(19) United States
(12) Patent Application Publication
(10) Pub. No.: US 2013/0085609 A1
(43) Pub. Date: Apr. 4, 2013

(54) OCCUPANCY DRIVEN PATIENT ROOM ENVIRONMENTAL CONTROL

(71) Applicant: Kimberly Ann Barker, Palatine, IL (US)

(72) Inventor: Kimberly Ann Barker, Palatine, IL (US)

(73) Assignee: Siemens Industry, Inc., Alpharetta, GA (US)

(21) Appl. No.: 13/474,231

(22) Filed: May 17, 2012

Related U.S. Application Data
(63) Continuation-in-part of application No. 13/398,593, filed on Feb. 16, 2012.
(60) Provisional application No. 61/541,653, filed on Sep. 30, 2011.

(51) Int. Cl. G05B 15/02

(52) U.S. Cl. 700/276

(57) ABSTRACT

Using a real-time location system, the hospital environment is controlled locally. By categorizing individuals detected at different locations, the proper control may be provided to enhance energy savings and maintain a comfortable patient environment without sacrificing safety. By altering the environment within a room for patients and not staff and/or based on the type of patient, more optimized and localized control may be provided, such as implementing a number of air changes per hour appropriate for detected patients within rooms.

### CLAIM FOR PRIORITY

This patent document is a continuation-in-part of U.S. patent application Ser. No. 13/398,593, filed Feb. 16, 2012, which claims the priority benefit under 35 U.S.C. §119(e) of U.S. provisional patent application Ser. No. 61/541,653 (2011P01756US), filed on Sep. 30, 2011, the contents of which are hereby incorporated by reference.

### TECHNICAL FIELD

This patent document generally relates to environmental control systems, and more particularly to a patient room environmental control.

### BACKGROUND

Medical facilities (e.g., hospitals, nursing homes and outpatient facilities) in general, and patient rooms in particular, are designed and configured to strike a balance between medical care, patient comfort, and efficient operation. Guidelines such as ASHRAE Advanced Engineering Guide for Small Hospitals and Healthcare Facilities; LEED 2009 for Healthcare EQ Credit 6.1, Controllability of Systems: Lighting and EQ Credit 6.2, Controllability of Systems: Thermal Comfort; and FGI 2006, AIA 2006, 2.1-10.3.5.2 are intended to help these facilities provide the best possible environment for patients while maximizing the ability to provide medical care and operate in an efficient manner.

These guidelines provide and recommend different environmental controls for different rooms. For example, a protective environment room is set for twelve air changes per hour with a positive pressure. An anteroom may be set for ten air changes per hour. Page: 3

Major air changes may be reduced for energy savings, but room pressurization must be maintained. When a room is not being used, the air may be changed just six times per hour, reducing costs. Building automation systems in hospitals may not be able to implement these environmental controls. Instead, the settings are left in the control of users for manual implementation. However, such manual implementation may result in inefficiencies. The hospital may not receive the energy savings otherwise available.

### SUMMARY

The disclosed system, non-transitory computer readable media, and method for patient room environmental control provide detailed examples of how required features and functionalities may be implemented and provided in a medical facility, such as a hospital environment. Moreover, the disclosed embodiments may be utilized in conjunction with a building automation control system and/or environmental control system in order to optimize energy performance for the structure, such as maintaining patient room environment pursuant to regulations or guidelines.

Using a real-time location system, the medical facility environment is controlled locally. By categorizing individuals (e.g., patient verses medical staff) detected at different locations, the proper control (e.g., occupied verses unoccupied) may be provided to enhance energy savings. By altering the environment within a room for patients and not staff and/or based on the type of patient, more optimized control may be provided automatically, such as implementing a number of air changes per hour appropriate for detected patients within rooms and implementing a different number for rooms without patients.

In one embodiment, a method is provided for environmental control in a hospital. A ventilation system for a room of the hospital is operated at a first rate of air changes per hour. A presence of an occupant in the room of the hospital. The occupant is distinguished as a patient from other types of occupants. The type of patient is determined for the patient. The operating of the ventilation system for the room is controlled such that the first rate is changed to a second rate in response to the detecting of the presence of the occupant and that the occupant is the patient. The second rate is based on the type of patient. The patient no longer being in the room is detected. The operating of the ventilation system for the room is controlled such that the second rate is changed to the first rate in response to the detecting that the patient is no longer in the room.

In another embodiment, a non-transitory computer readable storage medium has stored therein data representing instructions executable by a programmed processor for environmental control in a medical facility. The storage medium includes instructions for detecting a location of a patient in a medical facility, identifying the patient or a patient category of the patient, and controlling an environment local to the location of the patient as a function of the identified patient or the identified patient category of the patient.

In yet another embodiment, a system is provided for environmental control in a medical facility. A memory is in communication with a processor. The memory is configured to store processor-executable instructions to: wirelessly detect a mobile device in a room of the medical facility; wirelessly receive an identifier of the mobile device; determine a number of air changes per hour setting as a function of the identifier; and control a ventilation system based on the number.

Other embodiments, configurations, modifications and variations of these summarized concepts are disclosed, and each of the disclosed embodiments can be used alone or together in combination. Additional features and advantages of the disclosed embodiments are described in, and will be apparent from, the following Detailed Description and the figures.

### BRIEF DESCRIPTION OF THE FIGURES

FIG. 1 illustrates an exemplary patient room configuration that utilizes a unified patient room interface and implements the controls as disclosed herein;

FIG. 2 illustrates a functional block diagram of the exemplary unified patient room interface shown in FIG. 1

FIG. 3A depicts a logical block diagram of an exemplary control program that may be implemented by the controller of the exemplary unified patient room interface;

FIG. 3B depicts an example of simple object access protocol (SOAP) communication that may be generated by a SOAP interface routine portion of the control program of FIG. 3A;

FIG. 4 illustrates an exemplary user interface that may be presented by the unified patient room interface of FIG. 2;

FIG. 5 is a flowchart representing one operational embodiment of the control program that may be implemented in accordance with the teaching disclosed herein;

FIG. 6 illustrates another exemplary user interface that may be presented by the unified patient room interface of FIG. 2;

FIG. 7 illustrates another exemplary user interface that may be presented by the unified patient room interface of FIG. 2;

FIG. 8 is a flow chart representing one embodiment of registering a patient for environmental control in a medical facility;

FIG. 9 is a flow chart representing one embodiment of a method for environmental control in a hospital; and

FIG. 10 is a block diagram of one embodiment of a system for environmental control in a medical facility.

### DETAILED DESCRIPTION

An integrated solution for localized environmental control in a medical facility is provided. A patient room environmental control system is driven by occupancy. The integrated solution for patient and other medical facility rooms includes a building management system, such as a heating, ventilation, and air conditioning (HVAC) automated building control system (e.g., APOGEE Insight from Siemens Building Technologies). Other building automation control systems and/or HVAC units may be used. The integrated solution may also include a real-time location system, such as the Ekahau system from Siemens. Other locations systems may be used. The integrated solution may include a SOAP interface for managing communications between the components. Other communications may be used.

This integrated solution provides a patient room environment (i.e., ventilation, temperature, lights, windows, and blinds) to be adjusted based on patient occupany (e.g., real-time location of patient). If staff is present and not a patient or no person is present, then the environment controls are automatically operated in an energy savings mode. If a patient is present, then the environment controls are automatically operated as appropriate for the patient or type of patient. For example, rooms occupied by an infectious or immune deficient patient may have a greater number of air changes per hour than rooms occupied by other patients.

Lighting, temperature, blinds, or other environmental settings may be specific to the patient or type of patient. When a patient enters a room, such as after therapy or even for therapy, the occupancy by the specific patient or type of patient may be used to change environmental settings as appropriate or preferred by the patient. For example, a patient undergoing treatment related to vision may be associated with low light settings. Occupant detection may be used to control light levels for that patient. Such changes may or may not be made for staff.

By providing occupancy-based control of the HVAC system, energy efficiency may be optimized. Using the integrated solution throughout a medical facility provides global building control strategy for patient comfort and cost reduction.

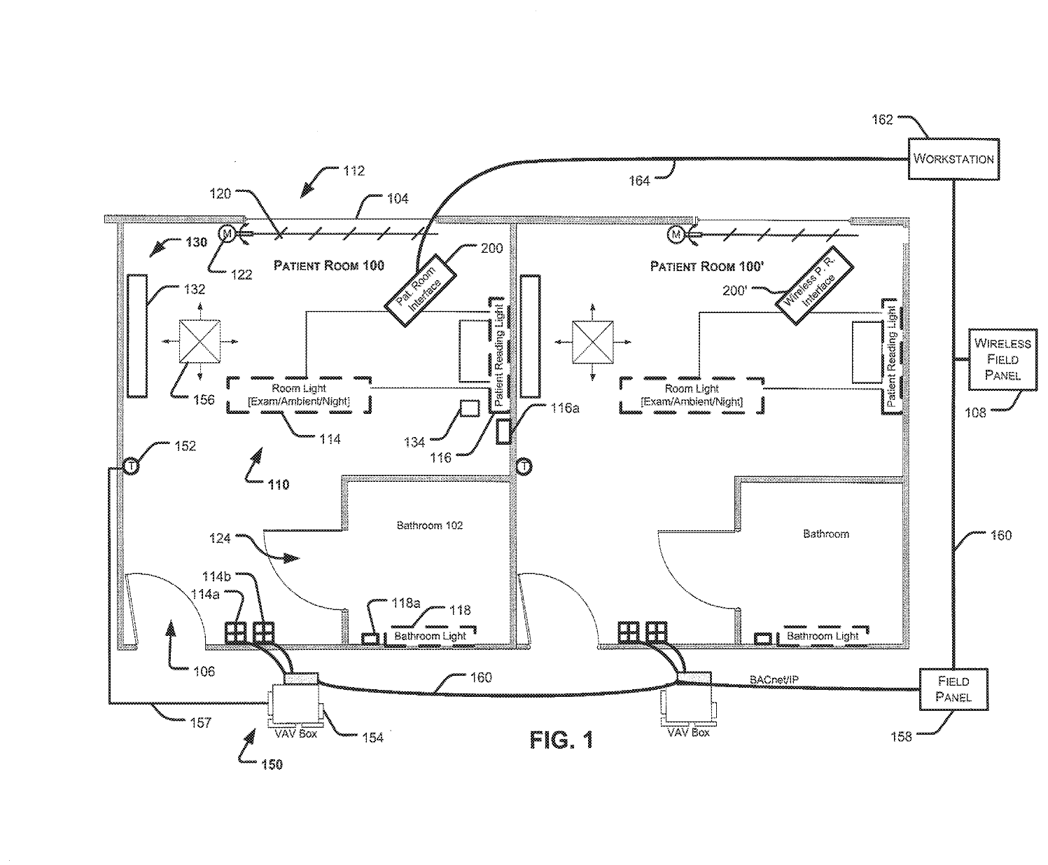

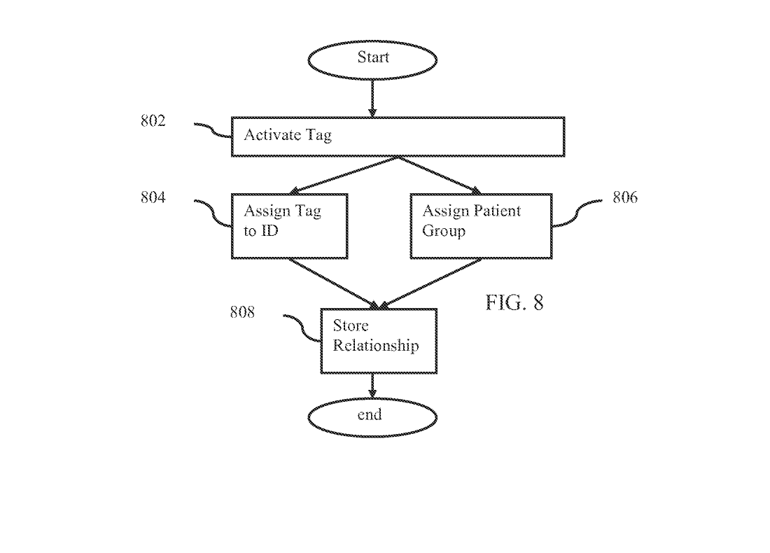

FIGS. 1-7 are directed to a patient room environmental control system. This system may be used with a real-time location system for controlling the environment in any room of a medical facility based on occupancy. The operation of the integrated solution based on occupancy is discussed below with respect to FIGS. 8-10. The patient may be provided with some freedom to control the environment in addition to the automated control based on detection of occupancy by a specific patient or patient type. The environmental control for patient input and general operation of the control structure are then discussed with respect to FIGS. 1-7. The patient room environmental control system is also described in U.S. Published patent application Ser. No. 13/398,593, filed Feb. 16, 2012, titled System and Device for Patient Room Environmental Control and Methods of Controlling Environmental Conditions in a Patient Room, the disclosure of which is incorporated herein by reference.

FIG. 8 is a flow chart diagram of one embodiment of a method for activating a locator (e.g., tag) for occupancy-based environmental control. The method is performed by a processor, such as a processor of a computer or terminal, as a server associated with hospital admissions, environmental control, location detection, and/or communications or as a controller in a panel or workstation, such as a field panel, controller, or computer. The method is performed in the order shown or a different order. Additional, different, or fewer acts may be provided, such as performing act 804 and not act 806 or vice versa.

In act 802, a tag is activated. The tag is any device which may be used to detect a location of an occupant. For example, the tag is a radio frequency identification device (RFID). The RFID tag responds to transmission or radio frequency waves with an identification. As another example, the tag is a powered device, such as a transmitter or transceiver. For example, the tag is a Bluetooth or Wi-Fi device for establishing communications with one or more access points. In yet another example, the tag is a cellular device. In one embodiment, tags used in real-time locations systems for equipment tracking are used.

The tag is activated by powering on the tag. Alternatively or additionally, the tag is activated in a database. By indicating that the tag is being or will be used, the tag is activated in the location tracking system. Any activation sequence or process may be used.

In one embodiment, a patient is provided a wrist band, clip on device, or other worn device with the tag when checking in or registering with the medical facility. As part of registering, the tag is activated. A hospital administrator locates an identifier, such as a serial number, of the tag. The identifier is entered into a database with the patient information. In other embodiments, the administrator powers on or causes the tag to transmit. Based on the current patient being registered in the system, the transmission by the tag is detected and used to assign the tag to the patient.

In other embodiments, staff are provided with tags to wear. The tags may be activated as part of new employee processing. Work flow or other efficiency in staffing or procedure may benefit by locating staff at different times. Reminder systems may use the locations, such as to remind a physician approaching a surgical suite to wash their hands. Alternatively, the staff do not have location tracking tags.

Tags may also be used for and removeably affixed to equipment. The tags may ease locating equipment needed by medical professionals.

In act 804, the tag is assigned to a specific patient identification. The patient may be assigned an identifier unique to the patient. The patient name, social security number, random number, or other identifier is used. The identifier is one assigned by the hospital for identifying the patient for any purpose. Alternatively, the identifier is generated and used specifically for patient tracking or occupancy detection. For example, the patient identifier is assigned as the tag identifier.

In act 806, a patient group is assigned. As an alternative to or in addition to associating a specific tag with a specific patient, the specific tag may be associated with a patient group.

Any grouping may be provided. For example, the groups include infectious, immune deficiency, burn, pediatric, cardiac, or other category. The categories may be based on type of treatment, type of illness, physician group, age, or other division. The categories may be categories used by the medical facility for other purposes. The categories may instead be specific to environmental control. For example, the categories are ones incorporated into the ASHRAE standard, such as ASH RAE Std. 170-2008 standard for environmental control, and/or into Facilities Guidelines Institute (FGI) for design and construction of healthcare facilities. By assigning a type of patient to a given tag, the environment appropriate for a current occupant is used rather than controlling room environment based on identification of the room.

In act 808, the automatically associated or manually entered link between the tag and the patient is stored. The tag identifier is stored with reference to the specific patient (e.g., a patient identifier) and/or to the group to which the patient belongs.

The storage is in a database. Any database may be used, such as a patient record database, picture archival and communications system (PACS), environmental control database, location system database, and/or a database for the environmental control system.

The data is formatted for searching and/or cross-referencing the tag identifier with the patient and/or patient group. The locater system or environmental control system may access the database to look-up patient information given the tag identifier. Alternatively, the data is formatted for a given system and a SOAP or other interface is used to re-format as needed.

In alternative embodiments, the storage is within the tag. The patient identification and/or group are input to the tag. The input is wireless, such as through the locater system. Data is transmitted through the real-time location system to the tag for storage. Alternatively, the data is entered through a user interface provided on the tag. The tag stores the identification and/or group in a memory in the tag.

The tag may output the patient identifier and/or group. The locator system or environmental control system obtains the patient identification and/or group from the tag. Alternatively, the tag outputs a tag identifier. The locator system or environmental control system obtains the patient identification and/or group from cross-reference in the database.

Once activated, the patient or staff member wears the tag. For example, the tag is part of a wristband. The patient attaches the wristband around their wrist. As another example, the tag is included as part of a name badge worn by the patient and/or staff member.

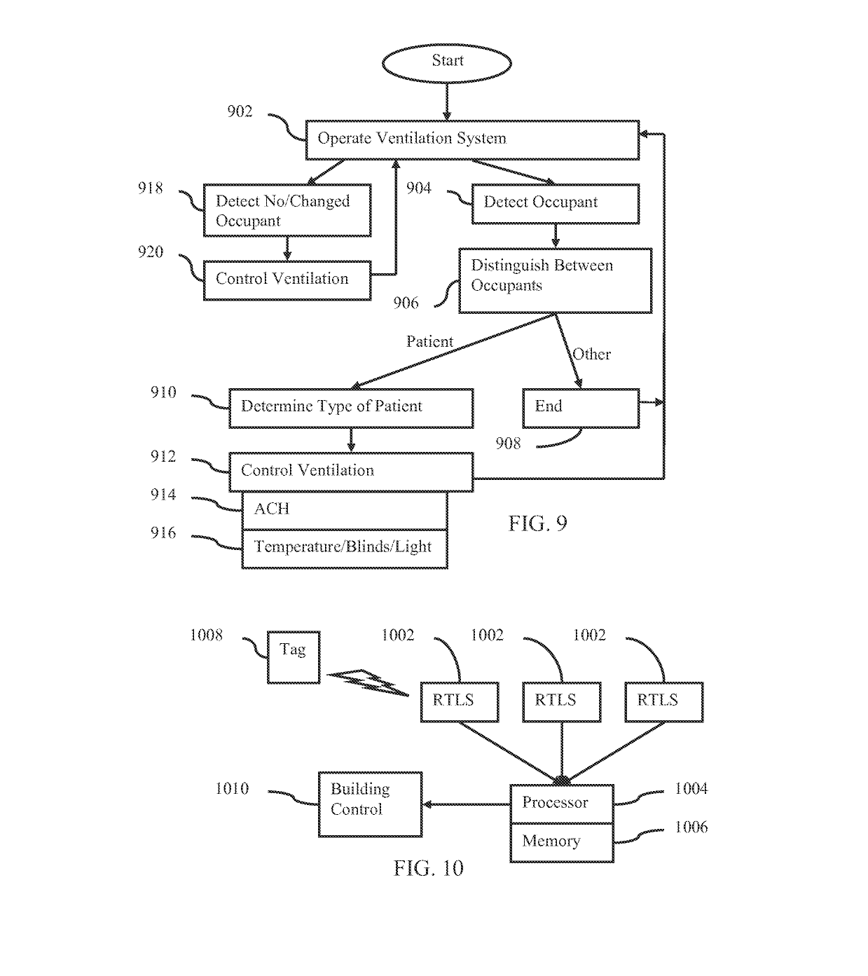

As the patient or staff member moves through or occupies space within the medical facility, the environmental control may respond to the location of the occupant. FIG. 9 shows one embodiment of a method for environmental control in a hospital based on occupancy detection. The method is implemented by the system described with respect to FIGS. 1-7, the system of FIG. 10, or a different system. In one embodiment, the method is implemented by a system with a HVAC unit, panels, associated workstation, actuators, and/or sensors. Patient controls may or may not be provided.

The method is performed in the order shown and described below. A different order may be used. For example, acts 914 and 916 may be performed at a same time or in reverse order.

Additional, different, or fewer acts may be provided. For example, one or both of acts 906 and 910 are not performed. As another example, act 916 and/or 914 are not performed.

In act 902, the ventilation system is operated. The ventilation system may be operated as part of an HVAC unit. Alternatively, the ventilation system is operated separately. Based on configuration from a server or workstation, panels and/or the HVAC unit programmably control actuators with or without feedback from sensors.

The ventilation system controls the air flow. The pressure may also be controlled. The ventilation system controls the air flow in various rooms within the medical facility. Each room may be controlled separately, such as using HVAC units, actuators, fans, or other devices to set the temperature, air changes per hour, and/or pressure for each room independently. Each room is controlled to maintain it's environmental requirements (i.e., temperature, Air changes, humidity, light levels, etc.). Room HVAC may be terminal units (e.g., Vav boxes, fancoil units) that receive their conditioned air from a central HVAC air handling unit (provides fresh air into building for ventilation). A given HVAC unit may be used for only one or multiple rooms. For multiple rooms, actuators and/or fans may allow for independent ventilation control for different rooms.

For air changes per hour, the ventilation system circulates air within the room. Conditioned air is added through one or more vents. Air within the room is withdrawn through one or more vents. By controlling the volume and/or rate of air flow into and out of the room, a desired number of air changes per hour may be established. The relative flow into and out of the room may establish the pressure. The pressure and air changes per hour are substantially maintained at desired or set levels. Substantially is used to account for tolerances, difference due to doors or windows being opened or closed, or other factors common in ventilation control.

Different rooms may have different pressure and/or air changes per hours settings. For example, an unoccupied room may have a setting of substantially six air changes per hour (ACH). To reduce energy use in hospitals, the minimum total air change may be reduced to six ACH when the room is not being used by an infectious patient. Pressure relationships to adjacent spaces may be negative in this scenario. For an occupied room, greater ACH is used. The ACH and/or pressure for an occupied room may depend on the occupant.

The occupancy of the room is monitored. Any monitoring technique may be used. For example, a motion sensor is provided. As another example, infrared or optical camera is used to detect an occupant by image processing. Such motion or optical detection may be used instead of tag-based detection.

In one embodiment, a signal from a tag is used. The tag may attempt to access a network, such as by exchanging information in a communications protocol. Triangulation, determination of the closest access point (e.g., signal strength), or other location technique is used to determine where the tag is located when accessing the network. Alternatively, the signal from the tag is in response to an interrogation. An access point or beacon sends a signal. When the tag receives the signal or signals, a response is generated. The response is an analog or digital wireless transmission. Through triangulation, signal strength, timing measurement, or determination of which beacon is communicating with the tag, the location of the tag is determined. In another alternative, the tag periodically transmits a signal without query by the location system. The beacon, access point or other sensor receives the transmission. Through triangulation, signal strength, timing measurement, or determination of which device is receiving the transmission, the location of the tag is determined.

A server or other computer of the real-time location system (e.g., computer connected with the beacons or access points) calculates the location. The measurements from the access points or beacons are provided to the server. The server determines the location from the measurements. In alternative embodiments, the location is determined without communication to the server, such as where the tag communicates with only one beacon. The server may be informed of the location.

In another approach, the tag determines the location or performs measurements used to determine the location. For example, the tag may measure the signal strength from various access points. The measurements are sent wirelessly to the location system and used to determine the location through triangulation.

In one embodiment, the location is determined by threshold and/or layout of sensors. For example, a beacon or measurement point is positioned in each room of interest. The beacon may transmit a signal of sufficient strength for communication with the tags in the room but insufficient strength for communication with tags in other rooms. The beacon may be directional to provide for inclusion and exclusion zones. Greater accuracy may be provided by finer resolution of the beacons, such as by providing a beacon adjacent to a bed area to distinguish location within the room. Any zone arrangement may be used.

The location of the occupant in the medical facility is detected. The location detection may track the occupants. The location of each occupant is monitored as the occupant moves within the facility. Alternatively or additionally, the detection is that a person is in a given room. Different rooms may be monitored.

The presence of an occupant in the room of the medical facility, such as a hospital, is detected in act 904. The real time location system wirelessly detects that a tag worn by a person is in a given room. For example, a patient returns to the room after treatment or imaging. Using a wristband or other patient tag, the presence of the patient in the room is detected. As another example, a patient enters a surgical suite, imaging room, or other room of the medical facility. The location of a tag is detected. The location is determined as within a zone, such as within a room. Micro-zones, such as location within the room, may be used.

In act 906, the type of occupant is determined. The server of the location system determines the type of occupant. Alternatively, the location information is provided to another server, such as a hospital network server, database server, or HVAC server. The other server determines the type of occupant. Workstations or connected computers may determine the type of occupant.

The detected occupant is distinguished by type. Any type may be used, such as staff or patient. Other types of occupants may be distinguished, such as cleaning staff from medical personnel. In alternative embodiments, the type of occupant is not determined. That an occupant is in the room is used with a type of room to control the environment.

The type of occupant is determined based on information from the tag. In a response signal or other wireless communication from the tag, identification information is transmitted. The identification information may be a tag identifier, patient identifier, staff identifier, staff group identifier, patient group identifier, or type of occupant identifier. In an alternative embodiment, the identifier is of the environmental settings appropriate for the person associated with the tag.

In one embodiment, a beacon or access point receives a tag identifier. The tag identifier is transmitted to a server or workstation. The server or workstation queries a database. Using the tag identifier, the associated information is accessed from the database. By referencing the database, the type of occupant may be distinguished. The database may include information indicating the type of occupant, such as patient verses staff. Alternatively, the patient identification or grouping is accessed from the database. For example, a patient identification is determined from the database using the tag identifier. The patient identification or grouping may be used to indicate the type of occupant as a patient. All other occupants are treated as not patients.

One database includes cross-reference information for all tag users, including staff and patients. Different databases may be used. For example, one database is for patients and another database is for staff. The tag identifier may be used to query one or both databases. Finding an identification or grouping for the occupant in one database may avoid the need to query another database.

Where the occupant is identified as staff or not a patient, the environmental control process may end in act 908. The settings of the ventilation system are maintained the same. For a patient centric environmental control, the environment is not altered for staff. For example, a nurse enters to restock or a housekeeping employee enters to clean the room. The ACH, pressure, temperature, or other environment settings are kept the same, such as in the energy savings mode unless manually overridden. The process returns to act 902 for continued operation of the ventilation system.

In an alternative embodiment, the determination of other than a patient being in the room is used to alter the settings of the ventilation system. Acts 910 and 912 may be performed based on the type of staff or non-patient occupant. The control is the same or different as for patients. For example, the lighting and temperature are increased, but the pressure and ACH are maintained, for staff. The settings for staff in general or specific groups of staff may be the same or different than for patients or specific groups of patients.

When the occupant is determined as a patient, the type of patient may be determined. In act 910, the type of patient is determined. This determination may be made sequentially with or simultaneously with distinguishing the occupant as the patient or not. For example, the database query to determine the type of occupant may return the type of patient for the occupant. The same response provides both the type of occupant (e.g., patient or not) and the type of patient (e.g., infectious, immune deficient, pediatric . . . ). In other examples, the determinations are sequential. Using a patient identifier, the same or different database may be queried to categorize the patient.

A database query may be used to find the type as previously entered or determined. The type of patient is entered for the tag or within the patient medical record for the patient assigned to the tag. Alternatively, available information is used to categorize the patient. Using the physicians associated with treating the patient, the billing codes, prescribed drugs, the wing housing the patient, or other information may indicate the type of patient. Using the patient record, a server may obtain information and categorize the patient.

Any categories may be used. For example, patients are categorized as infectious, pediatric, burn, immune suppressed, therapy, cardiac, catheter, trauma, or other label. Any categories of patient based on a particular hospital, a standard, or recommendation may be used. For example, the patients are categorized similar to categorizing of the types of patient rooms or other standards providing for ACH levels. For example, if a patient is admitted for eye surgery, then the ACH level for an eye surgical suite is assigned to the patient.

In act 912, the environment local to the location of the patient is controlled. The local environment is the room in which the patient is located. Larger or smaller spaces may be controlled. For example, the ventilation system may allow for directed or sub-room control. As another example, the ventilation system may control multiple rooms (e.g., patient room or rooms and any associated bath rooms).

The control of the local environment is based on the identified patient or the identified patient category of the patient. For the identified patient, the control may be for satisfying the comfort level of the occupant. For example, the temperature and ACH may be set for the identified patient based on that patient's tolerance of air flow and desired temperature. The range of settings may be limited, such as having a minimum ACH.

For the type of patient, the control may be to match the type with standards or appropriate settings for the condition of the patient. To limit the spread of infection or risk of air born illness, the number of ACH may be higher. For patients less susceptible to air born illness, the ACH may be lower to save costs. By using patient type and location detection, the ventilation is controlled in an optimized manner automatically meeting or exceeding health related concerns while reducing costs.

The control is for any type of room. The ventilation in the patient room or room for sleeping is controlled. The ventilation for other types of rooms, such as surgical suites, imaging areas, common spaces, protective environment rooms, or procedure rooms may be controlled based on the occupant.

Some rooms or types of rooms may not be controlled based on the occupant and/or type of patient. For example, common rooms do not alter ventilation due to the presence of a given occupant. As another example, surgical suites or procedure rooms are controlled manually. Alternatively, all rooms are controlled based on detected patient location or type of patient currently occupying the room.

Where more than one patient is in a room, the control may be set at a level appropriate for both patients. Where one patient is more susceptible to air born illness, the ACH may be set based on that patient. Alternatively, an average is used.

To control the environment, a processor of a server, workstation, computer, or panel of the ventilation system (e.g., building automation control, HVAC unit, or supervisory workstation) is used. The type of patient or patient identification is determined by or is provided to a processor. The processor determines the settings appropriate based on the detected occupant. Alternatively, the processor queries another device to determine the appropriate settings. For example, a panel may query a building automation server or supervisory workstation for the settings.

Any environmental characteristics may be controlled. The temperature, pressure, ACH, lighting (e.g., lights and/or blinds), or other characteristics are controlled. The characteristic is controlled using the control panels of the ventilation system, such as by operating actuators based on feedback from sensors. The characteristic may be controlled by operating at a set point without feedback. For example, light level is set without sensing.

In one embodiment represented by act 914, the number of ACH is changed based on the control. The rate of flow of air is changed. The ventilation system for a room with a detected occupant changes the ACH as appropriate for the occupant. Where the occupant is a patient, the ACH is changed. The change is made just based on the occupant being a patient, or the change is made based on the type of patient.

For example, a room is unoccupied. As a result, the ACH is at a power savings rate, such as a lower rate than when occupied by a patient. The ACH may be substantially six in one example. When a patient is detected in the room, such as when entering the room or during a location measurement performed after the patient entered the room, the ACH is changed. The ventilation system changes the ACH setting from the lower level ACH to a higher level ACH since a patient is in the room.

The level of ACH used may be based on the type of patient. Where the patient is infectious or has immune deficiency, the ACH may be one level (e.g., 15 ACH). Where the patient is at the medical facility for a check-up, a lower ACH level may be used (e.g., 10 ACH). Different categories of patients may be associated with different rates of air change. Alternatively, the level is based on whether a patient of any type occupies the room (e.g., 6 ACH for no patient currently located in the room and 15 ACH for any patient currently located in the room).

When the patient enters the room, the ACH is increased. The increased ACH may require more energy, but provides for the occupancy by a patient in the room.

In act 916, other aspects of the environment are controlled based on the current occupancy by anyone, occupancy by the type of patient, occupancy by a specific patient, and/or occupancy by a patient. The temperature, lighting, blinds, pressure, or combinations thereof are controlled based on the identification, such as the patient individual identification. The temperature, lighting, and blinds may be a matter of personal preference. The patient may establish a desired setting, such as using the controls discussed below. Scenes may be used for establishing the setting. Once the patient is detected in the room or other rooms, the settings for that patient may be used automatically.

Pressure, like ACH, may be changed based on patient preference and/or limited or set based on the type of patient. For example, rooms associated with infectious patients may have a negative pressure so that any air born germs emitted by the patient are less likely to flow into another room. As another example, rooms associated with an immune suppressed patient may have a positive pressure so that air possibly carrying germs is less likely to enter the room. As these patients move to other locations, the appropriate settings of the HVAC unit or ventilation system follow automatically.

When a patient or other occupant leaves the room, the lack of the particular occupant or any current occupant is detected in act 918. No occupant may be detected due to tracking occupant(s) as they leave the room. Alternatively, no occupant may be detected due to failure to detect a tag during a measurement cycle. The occupant may leave from one measurement cycle to the next.

The failure to detect may be of a specific patient or patient of a particular category. For example, a staff member leaves the room, but the patient remains. In the patient centric approach, the process continues at act 904 as if having detected a patient or stays at act 902 as there is no change (e.g., the ACH is already set for the patient). As another example, the patient leaves the room but a staff member remains. In the patient centric approach, no patient occupant is detected. As a result, the room is treated as unoccupied.

Where a patient and/or staff member remains despite a change in occupancy, the occupancy of the room is considered the same or not. Based on the remaining occupants, the ventilation system operation may be changed or not.

With the change in occupancy, the operation of the ventilation system is controlled, such as in act 920 or through act 912. For a change in occupancy with a person remaining, the process through acts 904-916 may be performed. For a change in occupancy with no person remaining, act 920 is performed. A table of current occupants may be kept. If the same occupant or same patient occupant is detected, any further detections or determinations may be avoided. By referencing the table and determining a same occupancy or same patient occupancy, the operation of the ventilation system may continue in act 902 with using network bandwidth or processing to perform other detection related actions.

In act 920, the operation of the ventilation system is controlled. The settings associated with the room are changed from an occupied level to a non-occupied level. The change is performed when all occupants leave, when all patient occupants leave, or when one or more but not all patient occupants leave.

In the ACH example, the ACH is at a level appropriate for the type of patient when the patient occupied the room. When the patient leaves, then no patient is detected in act 918. The ACH is set to an energy savings level. For example, the ACH is changed from 10-16 ACH to 6 ACH. Other energy savings levels may be used, such as 6-10 ACH. When one patient leaves, but another remains, the ACH is set to a level appropriate for the remaining patient. The air changes per hour may be decreased in response to detection of no patient occupant, a different patient occupant, or a change in patient occupancy.

The pressure or other characteristics may alternatively or additionally change. For example, the HVAC unit is controlled in response to the lack of an occupant. The pressure may be maintained or changed, such as changing to a negative pressure from a positive pressure. The temperature may be reduced to save costs. The lighting may be turned off or reduced to save costs. The blinds may be opened or closed for more efficient temperature control.

FIG. 10 shows a system for environmental control in a medical facility. The system implements the method of FIG. 9, FIG. 8, or other methods. The system represents one embodiment of the system described with respect to FIGS. 1-3. Alternatively, the system represents building automation without input devices specifically for the patient.

The system includes real time locators 1002, a processor 1004, a memory 1006, a tag 1008 and a building controller 1010. Additional, different, or fewer components may be used. For example, the memory 1006 may be part of a separate database accessed through a SOAP interface and used for patient administration. As another example, the processor 1004 and/or memory 1006 may be part of the building controller 1010. In yet another example, the processor 1004 and/or memory 1006 are part of a real-time location system.

The real time locators 1002 are access points, beacons, or other sensors for detecting occupants. In one embodiment, the real time locators 1002 are part of a real time location system. The processor 1004 and/or memory 1006 or a different processor and memory operate the real time location system. The real time locators 1002 transmit to and/or receive signals from tags 1006. The real time location system determines the location of the tag 1006 or other tags.

The real time location system, building controller 1010, processor 1004, or other system (e.g., sever) identifies the patient, type of patient, and/or type of occupant from the signals received by the real time locators 1002. The location of the tag 1006 is received by the processor 1004 and/or memory 1006. The processor 1004 and/or memory 1006 also receive or obtain the identification information.

The processor 1004 and/or memory 1006 are part of the real-time location system, the building controller 1010, a communications server, a database, a hospital network, a hosting server, an administrative computer, a workstation, or other computing resource available to the medical facility. The processor 1004 is a control processor, general processor, application specific integrated circuit, field programmable gate array, digital components, analog components, hardware circuit, combinations thereof and other now known or later developed devices for processing information. The processor 1004 is a single device or collection of devices, such as associated with distributed processing.

The processor 1004 is configured with computer code stored in the memory 1006. The memory 1006 is a non-transitory computer readable storage medium having stored therein data representing instructions executable by the programmed processor for controlling room environments in a medical facility based on occupancy. The instructions for implementing the processes, methods and/or techniques discussed herein are provided on computer-readable storage media or memories, such as a cache, buffer, RAM, removable media, hard drive or other computer readable storage media. Computer readable storage media include various types of volatile and nonvolatile storage media. The functions, acts or tasks illustrated in the figures or described herein are executed in response to one or more sets of instructions stored in or on computer readable storage media. The functions, acts or tasks are independent of the particular type of instructions set, storage media, processor or processing strategy and may be performed by software, hardware, integrated circuits, firmware, micro code and the like, operating alone or in combination. Likewise, processing strategies may include multiprocessing, multitasking, parallel processing and the like. In one embodiment, the instructions are stored on a removable media device for reading by local or remote systems. In other embodiments, the instructions are stored in a remote location for transfer through a computer network or over telephone lines. In yet other embodiments, the instructions are stored within a given computer, CPU, GPU or system.

The memory 1006 or a different memory includes data used by the system. For example, the memory 1006 is a database relating tag identifiers with people, staff, patients, types of patients, or other recorded information. The settings for HVAC control associated with specific tags and/or identifiers are stored. Alternatively, the processor 1004 determines the settings based on the identifier.

The memory 1006 communicates with the processor 1004. The communication is over a bus or traces in a circuit board. Cabling may be used, such as for communications over a network. Wireless communication may be used. Any communications format may be used.

The processor-executable instructions stored on the memory 1006 configure the processor 1004 to wirelessly detect a mobile device in a room of the medical facility. The processor 1004 receives measurements from the tag 1006 and/or the real time locators 1002. The measurements are wireless, such as using radio frequency transmission and/or reception. The mobile device is the tag 1006, but could be other devices and/or the occupants themselves.

To detect the occupant, an identifier of the mobile device is received. The identifier is of the mobile device (e.g., the tag 1002) or for the person associated with the mobile device. Where the identifier is for the mobile device, the identifier is used to identify the person or membership category of the person associated with the mobile device. Image processing may be used to identify the person.

The processor 1004 is configured to determine a number of air changes per hour and/or other environmental settings. Using the type of occupant, type of patient, and/or patient identifier, the processor 1004 calculates the settings. The settings may be accessed as a table. Alternatively, the settings are calculated using a function with any variables.

In one embodiment, the number of air changes per hour is determined. The type of patient assigned to the identifier is used to look-up or establish the number of air changes. The current occupancy is used to control whether the setting changes. For example, the number is maintained at a first value for any identifier assigned to staff and is increased upon detection of the mobile device with the identifier assigned to a patient new to a room.

The processor 1004 is configured to control the ventilation system based on the number. The processor 1004 communicates to the building control 1008. Command data or signals are sent to indicate the setting for the environmental controls in a room. The settings for different rooms are controlled.

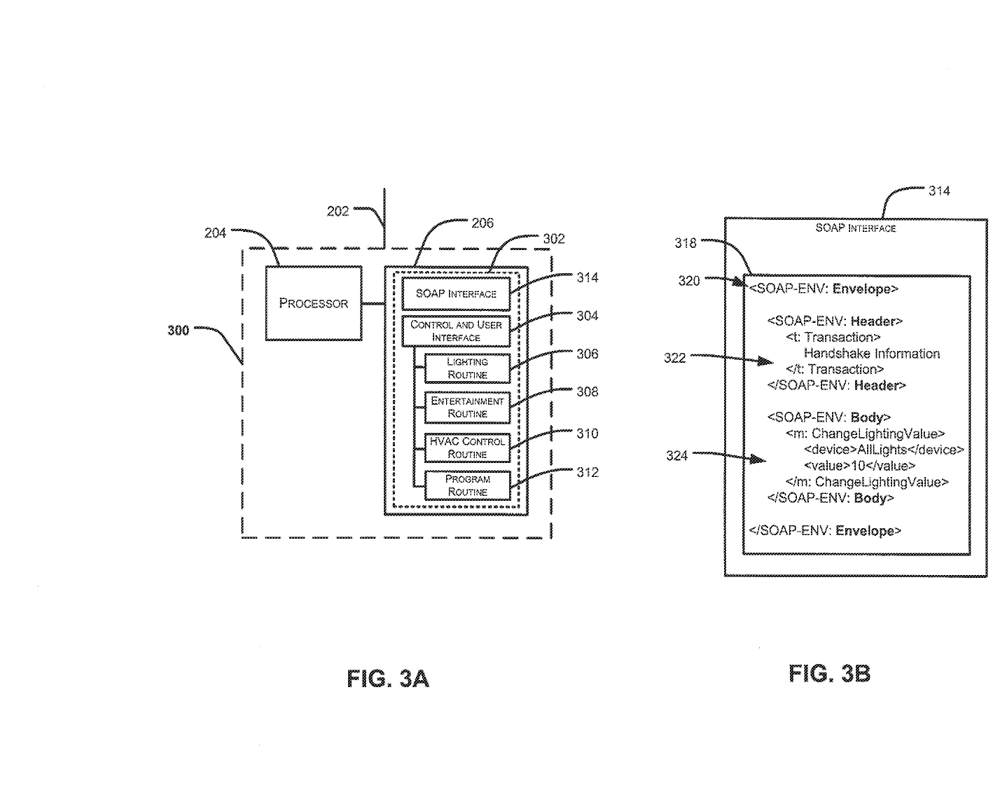

The building controller 1010 is an environmental control system, HVAC unit, panel, supervisory workstation, or other controller of the ventilation and/or other environmental parameters. For example, the controller 1010 is the workstation 162 or field panel 108, 158 in FIG. 1 or the controller 300 of FIG. 3A. The building controller 1010 receives the commands or settings from the processor 1004 or accesses the settings in the memory 1006. Alternatively, the building controller 1010 receives location and identification information and determines the settings.

Using the occupancy and identification information from the tag 1006, the system determines a location for the occupant. The location and identification are used to determine settings appropriate for the occupant. The settings change as the occupancy changes. This automated control may be more efficient, save costs, and/or increase patient comfort.

Referring now to FIGS. 1-7, one example implementation for environmental control in a medical facility is provided. FIGS. 1-7 show a system and device for patient room environmental interface and control as well as the method of controlling environmental conditions in a patient room. The advantageous features and functionalities may be implemented and provided in a hospital environment. Moreover, the disclosed system and device may be utilized in conjunction with a building automation control system and/or environmental control system in order to optimize energy performance for the structure. For example, a daylight or ambient light sensor may be deployed in each patient's room and may operate in conjunction with one or more window shade and/or lighting controls in order to maximize or harvest available lighting to reduce energy costs associated with lighting and environmental controls. Alternatively, or in addition, an environmental control routine and more specifically a lighting control routine may be configured to selectively control the intensity and output of the lighting devices deployed within a patient's room and operate one or more window shade controls in order to maintain a constant level of illumination. Thus, as the ambient natural light level within a patient's room varies throughout the course the day, the intensity and output of individual artificial lighting devices may be varied to compensate for or otherwise maintain overall lighting level within the patient room or any other given area.

In other embodiments, the disclosed system and device may be integrated with the environmental control system operable within both the patient room and the overall hospital structure. For example, in one integrated embodiment, the patient may be empowered to control the room temperature, perform lighting adjustments as well as vary the position of the window shades without requiring intervention of hospital staff or leaving the safety and comfort of the patient bed. In this way, the patient's needs and comforts may be satisfied without incurring risk to themselves or otherwise utilizing the hospital staff to perform nonmedical or healthcare related tasks. The integrated embodiment therefore empowers both the patient and frees hospital staff and other personnel to pursue more efficient uses of their time. This patient control may be used in addition to automated control based on occupancy detection.

In another integrated embodiment, the disclosed system and device may be utilized to control individual heating, ventilation and air conditioning (HVAC) units deployed and arranged to control the environment within an individual patient room. In this way, each patient room may be adjusted to provide a customized HVAC and lighting solution specific to each patient's comfort level. Moreover, the disclosed system and device may be preconfigured with one or more system settings to provide, for example, maximum lighting conditions in which to perform procedures, in case of emergencies, or another setting to provide a relaxing ambient environment or other desired condition or event.

The embodiments discussed herein include environmental control devices, building automation devices and wireless automation devices incorporating or communicating with a transceiver. The embodiments may include BACNet, IEEE 802.15.4/ZigBee-compliant devices and components such as, for example, one or more personal area network (PAN) coordinators implemented as a field panel (FPX or PXC); a full function device (FFD) implemented as a floor level device transceiver (FLNX); and a reduced function device (RFD) implemented as a wireless room temperature sensor (WRTS). Regardless of the specific type and functionality of any given device or component, compliance with recognized building control and automation standards such as BACNet and/or ZigBee standards ensure communication and interoperability with the building automation network and system deployed within the structure. The devices and components identified herein are provided as an example of environmental control devices, building automation components, wireless devices and transceivers that may be integrated and utilized but are not intended to limit the type, functionality and interoperability of the devices and operation.

### I. Patient Room Configuration

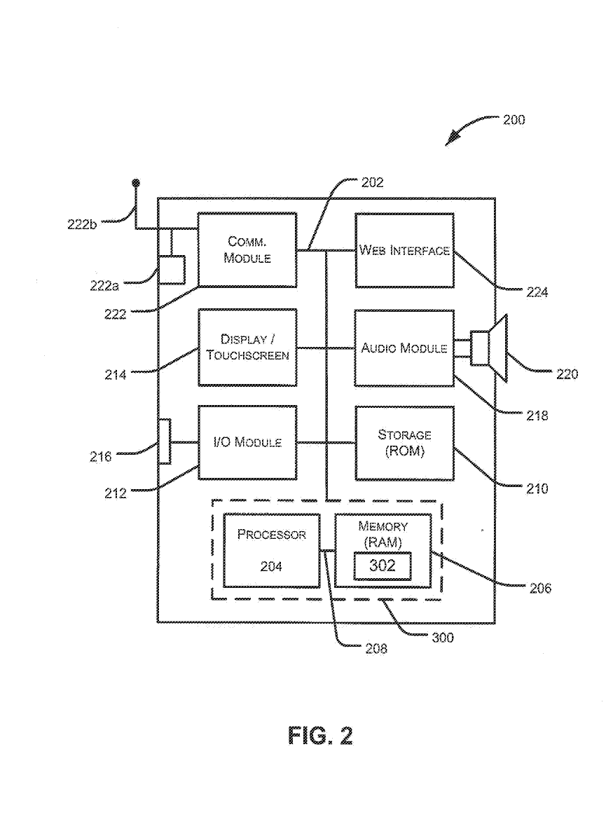

FIG. 1 depicts exemplary patient rooms 100 and 100′ that may be coupled to a unified patient room interface 200 and a unified patient room interface 200′ (see FIG. 2). In this embodiment, the patient rooms 100 and 100′ are substantially the same configuration and include substantially the same elements and devices. However, the unified patient room interface 200 of the patient room 100 is a wired device, while the unified patient room interface 200′ of the patient room 100′ is a wireless device. For the sake of convenience, the description and discussion provided herein focuses on the patient room 100. It should be understood that the principles set forth herein are equally applicable to both the wired and wireless configurations of the unified patient room interface 200.

The exemplary patient room 100 includes and incorporates a room lighting system 110, an integrated entertainment system 130 and an environmental control system 150. These systems may be provided by different manufactures and operate according to different standards and control protocols. In one exemplary configuration, the room lighting system 110 may be a multi-grouped and multi-zoned system configured to holistically control the illumination within the patient room 100 as well as an attached bathroom 102. For example, the room lighting system 110 may incorporate a first lighting group to control ambient light levels using a window shade control system 112. The room lighting system 110 may further incorporate a second lighting group to control the artificial lighting devices deployed within the patient room 100. The second lighting group may include an overhead examination light 114, a patient reading light 116, and a bathroom light 118. The overhead examination light 114 and the patient reading light 116 may cooperate to define a first lighting zone within a main portion of the patient room 100 while the bathroom light 118 may define a second lighting zone within the bathroom 102.

The window shade control system 112, in this exemplary embodiment, mounts to and/or is carried by the frame of a room window 104 constructed into or onto an exterior wall of the patient room 100. The window shade control system 112 may include a shade or a plurality of shades 120 coupled to a positioning motor 122. The positioning motor 122 may be configured to raise or lower the shade or rotate the plurality of shades 120 to thereby adjust the ambient light allowed into the patient room 100 through the window 104.

The room lighting system 110 may be configured to allow for manual control of each of the lights 114, 116 and 118 using a corresponding wall switch 114a, 116a, and 118a. Each wall switch may be mounted at an accessible location for an intended user. For example, the wall switch 114a controls the overhead examination light 114 and may be mounted adjacent to the room door 106 for easy access by doctors, nurses, housekeeping staff and visitors as they enter the patient room 100. In one embodiment, the wall switch 114a may include or communicate with a light sensor 114b. The light sensor 114b may be a photo-sensor configured to detect the ambient lighting within the patient room 100. Another wall switch 116a may be mounted near the patient's bed to provide manual control of the patient reading light 116. Similarly, the wall switch 118a may be mounted near the bathroom door 124 to allow for manual control of the bathroom light 118 within the bathroom 102. In another embodiment, the wall switch 118a may include a motion sensor (not shown) configured to automatically activate the bathroom light 118 when the patient or other person enters the bathroom 102.

The patient room 100 further includes the integrated entertainment system 130 to control and communicate with entertainment and/or communications equipment available to the patient. The integrated entertainment system 130 may include, for example, a television or monitor 132, a telephone or telecom system 134, a music system (not shown), a gaming console (not shown) or any other known or later developed entertainment device. The integrated entertainment system 130 may further control and connect with a local area network, a personal area network, a router, a network addressable storage device or other computing equipment. In another embodiment, the integrated entertainment system 130 may provide or act as a communication gateway for one or more cellular devices.

The environmental control system 150 may be designed and configured to control the room temperature and other air conditions or variables within the patient room 100. The environmental control system 150 may include a sensor 152 that may be configured to detect, for example, temperature; carbon monoxide; carbon dioxide; humidity and generate a sensor signal representative of the detected condition. The environmental control system 150 may further include or communicate with an HVAC unit 154. The HVAC unit 154 may be a water-source heat pump, a fan coil or a variable air volume (VAV) terminal unit such as a Zone Control Unit (ZCU) manufactured by Siemens Industry, Inc., Building Technologies Division (hereinafter referred to as “Siemens”). In one embodiment, the environmental control system 150 may provide direct or indirect control over the airflow delivered by the VAV terminal unit in order to allow the temperature, air flow, pressure, and humidity conditions within the patient room 100 to be adjusted. By interacting with and directing the airflow generated by an exemplary VAV terminal unit, the airflow volume delivered through the vent 156 may be adjusted. In other embodiments, the HVAC unit 154 may be controlled to change the temperature of the airflow delivered via the vent 156.

The automation devices and systems of the room lighting system 110, the integrated entertainment system 130 and the environmental control system 150 may, in one embodiment, be hardwired to a typical 120V/240V power source that supplies the patient room 100. Similarly, the automation devices and system may utilize existing network and infrastructure wiring to communicate information. For example, the sensor 152 may communicate temperature information or data to the HVAC unit 154 via a wired connection 157. This information and data may, in turn, be communicated to an APOGEE® field panel (FPX or PXC) 158 and/or a building automation workstation 162 via a building automation network 160. In this embodiment, the building automation workstation 162 may be an INSIGHT® building automation workstation and the building automation network 160 may be a compatible BACnet/IP network both of which are manufactured and provided by Siemens.

Alternatively, or in addition to, the devices and systems may employ wireless technology such as, for example, IEEE 802.11 (Wi-Fi), IEEE 802.16 (WiMAX), IEEE 802.20 (wireless broadband), IEEE 802.15.4 (ZigBee) or any other known or later developed wireless standard or protocol. In this embodiment, the patient room 100 may include a wireless field panel 108 (FLNX) configured to wirelessly receive information, data or signals from the devices or systems operable within the room lighting system 110, the integrated entertainment system 130, and/or the environmental control system 150. For example, information and data from the sensor 152 may be wirelessly communicated to the wireless field panel (FLNX) 108 for communication to a field panel 158 such as an APOGEE® field panel (FPX or PXC) and/or the HVAC unit 154. The received information or data may retransmitted or otherwise provided to the building automation workstation 162 via the building automation network 160.

The building automation workstation 162, and more particularly the INSIGHT® application operable on the building automation workstation 162, is configured to collect and analyze information and data related to the patient room 100 from one or more automation devices deployed therein. Specifically, the INSIGHT® application is configured to utilize the received information to monitor and control the automation devices or systems operable within the room lighting system 110, the integrated entertainment system 130 and the environmental control system 150 according to one or more control routines or processes, such as the occupancy detection-based automated control. The control routines and processes may be designed to optimize the environmental controls and power usage through the structure controlled and monitored by the building automation system. The operation of the control routines and processes may further allow for manual control of one or more devices via manual controls and switches 114a, 116a and 118a disbursed throughout the patient room 100.

Control or interaction with elements of the room lighting system 110, the integrated entertainment system 130 and the environmental control system 150 may be further realized via a wireless connection established between the unified patient room interface 200′ and the building automation workstation 162. In another embodiment, the unified patient room interface 200 may be connected to the building automation workstation 162 via a wired connection 164.

### II. Unified Patient Room Environmental Control Device and Interface

FIG. 2 illustrates an internal block diagram of the unified patient room interface 200 that may be coupled to or in communication with the automation devices and systems within the patient room 100. In particular, the unified patient room interface 200 includes both the hardware of a patient control device and the controls that generate a user interface by which a patient may affect environmental control over the patient room 100 from a central location. For example, the disclosed patient control device is a bedside device configured to allow a patient to autonomously control one or more environmental conditions within the patient room 100. This autonomous control empowers the patient without increasing their risk of injury by requiring them to leave their bed to adjust and control the environmental conditions. By providing a patient with control over the environmental conditions (i.e., the lighting, the air temperature and/or airflow, and the entertainment and communication systems) within the patient room 100, the patient room interface 200 frees hospital personnel from having to perform these mundane tasks while at the same time empowering the patient at a time when they may normally feel powerless and vulnerable.

The internal block diagram representing the configuration of the unified patient room interface 200 illustrates individual functions and/or modules as separate logical entities in communication via a bus 202. These logical entities may represent individual physical components that may be assembled as a part of a printed circuit board (PCB). Alternatively, these functions and modules may be integrated into a single or limited number of physical components. These functions and modules may each represent a specialized computer program or processor-executable code configured to gather, process or otherwise manipulate patient commands and data to control or operate the automation devices or systems of the room lighting system 110, the integrated entertainment system 130 and the environmental control system 150.

The unified patient room interface 200 may include the controller 300 (see FIG. 3A) comprising a processor 204 and a memory 206. In one embodiment or configuration, the processor 204 may be a computer processor configured to receive commands or instructions from the user for communication to the building automation workstation 162 in order to control one or more of the automation devices or systems of the room lighting system 110, the integrated entertainment system 130, and/or the environmental control system 150. The memory 206 may be volatile memory such as random access memory (RAM), static RAM (SRAM), dynamic RAM (DRAM) or any other memory accessible by the processor 204. The memory 206 may operate as a register, cache, or virtual memory for the processor 204. In this embodiment, the memory 206 stores a control routine 302 (see FIG. 3A) for access and execution by the processor 202.

Alternatively, the controller 300 may be an application-specific integrated circuit (ASIC) programmed and/or customized to control and direct the operations of unified patient room interface 200. An exemplary ASIC may include an entire 32 or 64-bit processor, memory blocks including, but not limited to, read only memory (ROM), random access memory (RAM), electrically erasable programmable read-only memory (EEPROM), and flash memory. The ASIC could be utilized to replace the combination of the processor 204 and memory 206 within the exemplary controller 300.

In the present embodiment, the memory 206 and the processor 204 are arranged and configured to directly communicate with each other via a communication channel or dedicated bus 208. In another embodiment and configuration, the memory 206 may be shown to be in communication with the processor 204 via the bus 202. In this way, the processor 204 and the program module 206 may be maintained as separate and distinct devices within the unified patient room interface 200.

The controller 300 may be coupled to and in communication with a secondary memory or storage module 210 via the bus 202. In the present embodiment, the storage module 210 is illustrated as a separate element from the controller 300. However, in other embodiments the storage module 210 may be an integral part of the controller 300. The storage module 210 maybe any known or later developed computer readable medium and/or nonvolatile storage device such as, but not limited to, a hard drive, a solid-state drive (SSD), flash ROM (read-only memory) or an optical drive. The storage module 210 may be configured to accessibly store the information, data and executable files necessary to provide the desired functionality associated with the unified patient room interface 200. For example, the storage module 210 may store the operating system, programs, and executable algorithms utilized by the controller 300.

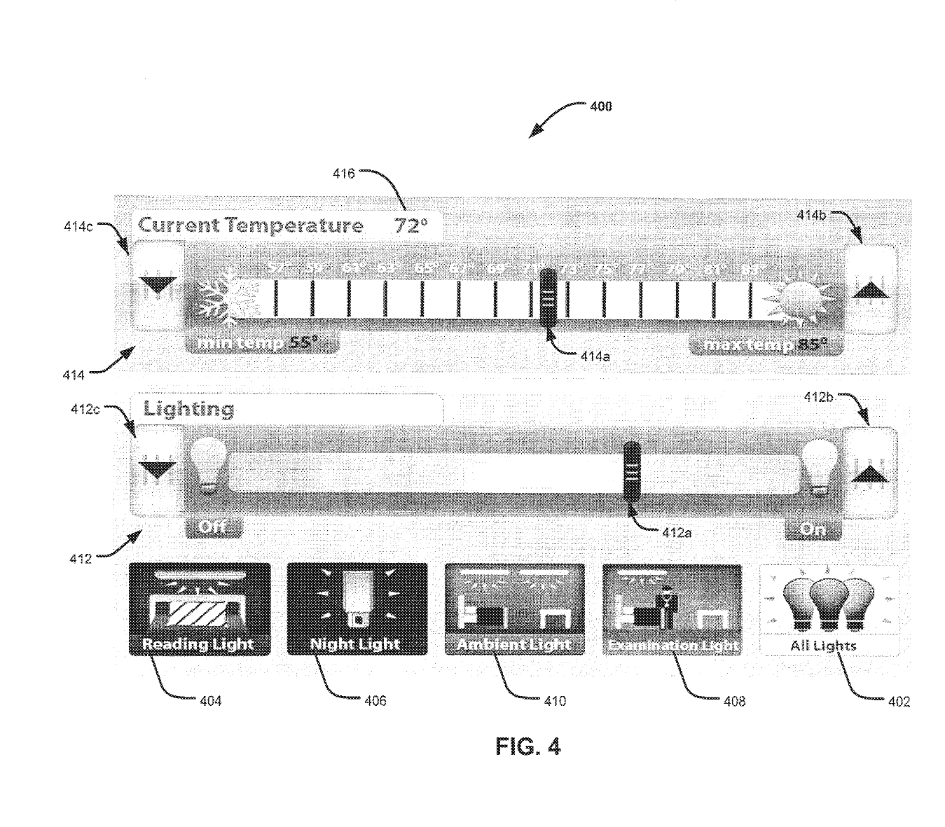

In operation, the processor 204 may communicate with and access information on the storage module 210 via the bus 202. For example, in order to generate a graphical user interface (GUI) or user interface 400 (see FIGS. 4A to 4C), the processor 204 may access an appropriate subroutine stored in the storage module 210 and executable from within the memory 206. The information necessary to generate the user interface 400 may, in turn, be communicated via the bus 202 to a display and/or touchscreen 214. The touchscreen 214 may be configured to receive information, selections and/or commands provided via a resistive or capacitive input layer (not shown) responsive to a user interaction. The touchscreen 214 provides an integrated mechanism by which the user interface 400 may be presented to a user. An I/O module 212 may augment and/or cooperate with the touchscreen 214 to process and translate information received via a keyboard (not shown), a mouse or trackball (not shown) or to present information via a simple monitor or display.

The I/O module 212 may further include one or more inputs 216. The one or more inputs 216 may be, for example, a secure digital (SD) card reader that augments or expands the capability of the storage module 210. Alternatively, or in addition to, an SD card (not shown) and the secure digital card reader may be utilized to transfer or update information, algorithms and programs contained within the storage module 210 for execution by the controller 300. The inputs 216 may, in another embodiment, be a connector or dock for a digital music player such as an iPod® or Zune® from Apple, Inc. or Microsoft Corp., respectively. In yet another embodiment, the input 216 may be a universal serial bus (USB) connector, a digital video interface (DVI) connector, a serial port connector or any other known or later conceived connection for communicating information between devices.

The unified patient room interface 200 may further include an audio module 218 in communication with the controller 300 via the bus 202. The audio module 218 may be configured to convert a digital sound file such as an MP3 or way file into an analog signal that maybe broadcast or played via a speaker 220. In one embodiment, the input 216 may connect to a digital music player (not shown) to allow the digitally stored music contained thereon to be converted or played by the audio module 218 and broadcast via the speaker 220. In yet another embodiment, the processor 204 may communicate or play music or other audio information via the integrated entertainment system 130 and the audio module 218.

A communication module 222 provides both wired or wireless communication capabilities that allow for communication with one or more of the automation devices or systems within the patient room 100. For example, the communication module 222 allows the unified patient room interface 200 to exchange information with the room lighting system 110, the integrated entertainment system 130, and the environmental control system 150 by way of the building automation workstation 162. In one embodiment, information or commands received via the touchscreen 214 may be processed by the controller 300 and communicated to the building automation workstation 162 via the wired connection 164 established with the communication module 222. The building automation workstation 162, in turn, transmits the information via the building automation network 160 to the wireless field panel (FLNX) 108 and/or the field panel 158. The field panels 108, 158 may then provide the information, in either a wired or wireless manner as appropriate, to one or more of the automation devices operable within the room lighting system 110, the integrated entertainment system 130, and the environmental control system 150. The communication module 222 may, in turn, receive information in the same manner discussed above. The received information may be presented via the touchscreen 214, stored within the storage model 210, and/or used by the controller 300 as an input in one or more routines or software discussed herein.

The communication module 222 may be configured to communicate via a powerline network, an Ethernet network, a two-wire network or other known networking configuration via a communications port 222a. In another embodiment, the communication module 222 may be configured to communicate according to IEEE 802.11 (Wi-Fi), IEEE 802.16 (WiMAX), IEEE 802.20 (wireless broadband), IEEE 802.15.4 (ZigBee), Bluetooth, or other known radio communications protocol, via a wireless transceiver 222b. The communications module 222 may be configured to operate as a dual mode communication module in order to provide both wired and wireless communications for increased flexibility. Alternatively, or in addition to, the communication module 222, when operating as a dual-mode communication module, may send and receive information according to multiple wireless communication protocols. For example, the communication module 222 may be configured to simultaneously communicate information according to IEEE 802.11 (Wi-Fi) and IEEE 802.15.4 (ZigBee).

In another embodiment, the communication module 222 may cooperate with a web interface 224 to establish an access portal for remotely viewing and/or monitoring information related to the room lighting system 110, the integrated entertainment system 130, and the environmental control system 150. The web interface 224 may, in conjunction with the communication module 222 access the Internet or other network for information or infotainment browsing via the touchscreen or display 214. In yet another embodiment, the web interface 224 provides a mechanism by which the information and capabilities of the unified patient room interface 200 may be accessed or controlled remotely via browser such as Microsoft's Internet Explorer® or Apple's Safari®.

FIG. 3A depicts a functional block diagram representation of the controller 300. In particular, FIG. 3A illustrates the processor 204 in communication with the memory 206 via the bus 208. The memory 206, in the illustrated representation, stores the control routine 302 executable by the processor 204 and configured to direct the operation of the unified patient room interface 200. The control routine 302 may, in turn, include numerous subroutines, software applications, and/or modules that, when executed by the processor 204, direct the operation of the automation devices or systems operable within the room lighting system 110, the integrated entertainment system 130, and the environmental control system 150.

The control routine 302 may include a control and user interface routine 304 configured to generate the graphical user interface 400 (see FIG. 4) and integrate the functions and operations of a lighting control routine 306, a entertainment control routine 308, an environment and/or HVAC control routine 310, and a stored program routine 312. Each of the routines 306, 308, 310 and 312 control and communicate with the automation devices or systems operable within the room lighting system 110, the integrated entertainment system 130 and the environmental control system 150. These systems, in turn, may operate according to different communication standards and protocols such as DALI, BACnet, LON, KNX and any other know or later developed standards and protocols.

The control routine 302 may be a self-contained program or firmware that includes the information, functions and libraries for the operation of the unified patient room interface 200. Alternatively, the control routine 302 may utilize one or more application programming interfaces (APIs) stored in, for example, the memory 206 to access and utilize information, functions and libraries accessibly stored on the storage module 210. The control routine 302 may further include or access one or more drivers to communicate information and data between, for example, the processor 204, the touchscreen 214, the audio module 218, and the communication module 222.

The control routine 302 further includes a simple object access protocol (SOAP) interface 314. The SOAP interface 314 provides for the different automation devices using difference communication protocols and standards to exchange information. By using the SOAP interface, an automation device that communicates according to a first protocol exchanges information in the form of data packets with a different automation device that communicates according to a second protocol. The SOAP interface 314 and data packets communicate information between the different automation devices as tag data in an extensible markup language (XML) stream format utilizing hypertext transfer protocol (HTTP). The extensible, text-based framework enables communications between the diverse automation devices without requiring either device to have knowledge of the others communication protocol and/or standard.

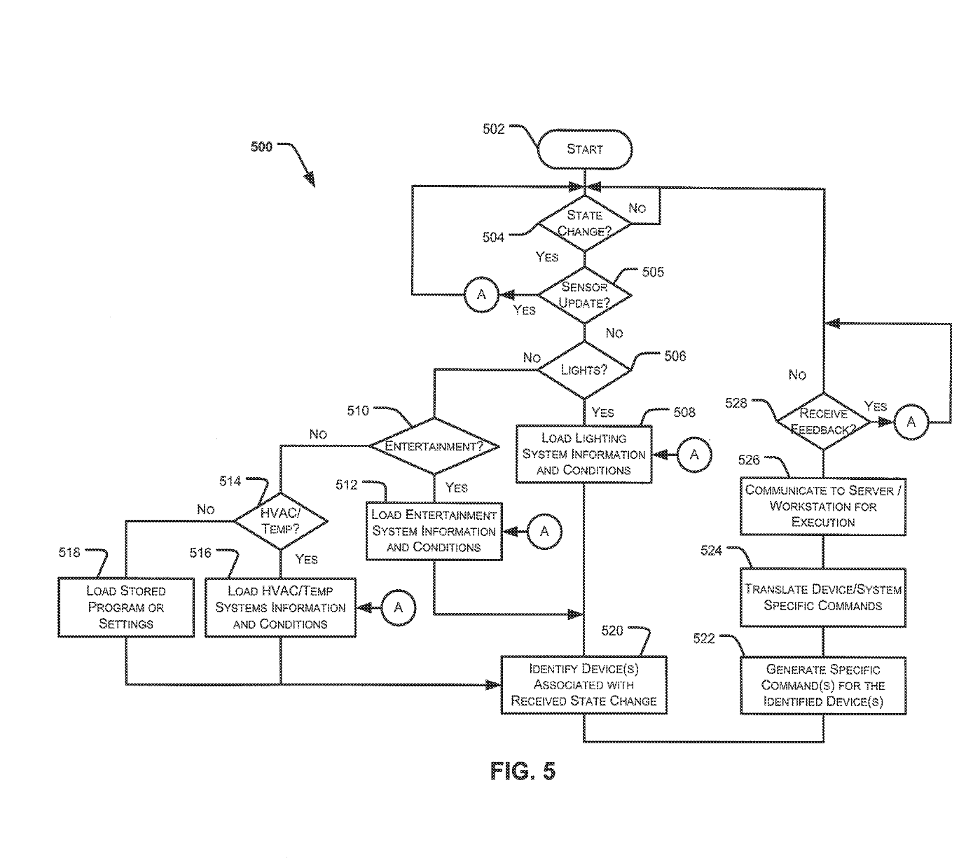

FIG. 5 is a flowchart 500 depicting one example of the operations and functions that may be performed by the control routine 302 when executed by the processor 202. In this embodiment, the control routine 302 activates (i.e., begins implementation of the steps and functions illustrated in the flowchart 500) when the unified patient room interface 200 is connected to and energized by a power supply (step 502). In another configuration, the control routine 302 may be activated in response to a user input provided via, for example, the touchscreen 214 or a power button (not shown). The control routine 302 may remain in an idle state (i.e., a continuous loop) until a change of state or state event associated with an environmental condition within the patient room being monitored is detected (step 504). The environmental condition(s) represented by the change of state or state event can include virtually any user-initiated change or other command that influences or alters the environmental within the patient room 100. For example, the change of state or state event is detection of an occupant and a change in occupancy. In another example, the change of state or state event represents a user command to adjust the temperature and/or airflow provided by the HVAC unit 154. In another embodiment, the state event reflects a change detected by one or more remote sensing or monitoring devices within the patient room 100, such as a real time location system. In yet another embodiment, a change of state may occur based on the initiation and/or expiration of a timer or a schedule (i.e., a time of day, day of the week, a seasonal period). State events may be custom programmable conditions defined at, for example, the building automation workstation 162 and/or predefined events and conditions provided by the INSIGHT® building control application executing on the building automation workstation 162.

Upon detection of a change of state or state event, the control routine 302 evaluates the state event to determine if it represents an update to a sensor value or a command to change the operation of one or more automation devices or systems operable within the room lighting system 110, the integrated entertainment system 130 and the environmental control system 150 (step 505). If the control routine 302 determines the state event to be a sensor update, the current state information is overwritten with the new sensor data (see steps 508, 512 and 516) and the control routine 302 returns to an idle state. Once the current state information has been updated, the control routine 302 then returns to an idle state (see step 504). However, if the state event represents a command directed to one or more of the automation devices operating within the patient room 100, the control routine 302 continues processing at steps 506, 510 or 514 based on the received state event.

An example of a state event that causes the control routine 302 to activate (i.e., leave the idle state) may be, for example, the user-selection of an ALL LIGHTS button 402 in FIG. 4 via the user interface 400 presented by the touchscreen 214. The user interface 400, in this exemplary embodiment, may be generated by control and user interface routine 304 operable in connection with the control routine 302. The control routine 302, and more particularly the control and user interface routine 304, analyzes the received selection to determine which routine or system the input pertains. In order to make this determination, the control routine 302 sequentially evaluates the received selection to determine if the selection is related to the lighting routine 306 (see 506), the entertainment routine 308 (see 510), HVAC control routine 310 (see 514) or a stored program routine 312 (see 518). Alternatively, the control routine 302 may analyze a flag or header associated with the received user selection in order to determine which of the routines 304 to 312 should be activated.

In the present example, the user selection of the ALL LIGHTS button 402 results in the activation of the lighting routine 306 portion of the control routine 302 (step 506). The lighting routine 306 may, in this exemplary embodiment, include the information, communication protocols, and values necessary to interact with the automation devices or systems operable within the room lighting system 110. For example, the lighting routine 306 may include the digital addressable lighting interface (DALI) information and commands required to communicate with and control the overhead examination light 114, the patient reading light 116 and the bathroom light 118 positioned within the patient room 100.

Once the lighting routine 306 has been identified and activated by the control routine 302, the current state information may be loaded (step 508) from, for example, the memory 206 and/or the workstation 162. The current state information, in turn, may be provided by, for example, the wireless field panel 108 and the field panel 158 communicating with the lights 114 to 118 and the window shade control system 112. The current state information may include, for example, the last known status for each of the lights 114 to 118, the status of the window shade control system 112 including the current position of the positioning motor 122 and the shades 120, as well as any information about the ambient light condition within the patient room 100 provided by the light sensor 114b. The user may update and adjust the current state information via the user interface 400 thereby causing the control routine 302 and the lighting routine 306 to display the revised information on the touchscreen 214 and/or store the revised information in the memory 206 or storage module 210.

The control routine 302 next determines which of the automation devices and systems operable within the room lighting system 110 are to be modified by the user selection and the lighting routine 306 (step 520). In the present example, receipt of a command or value associated with the ALL LIGHTS button 402 indicates that the each of the lights 114 to 118 are to be activated. The control routine 302 next identifies the specific commands and information for a first protocol, such as DALI protocol, utilized by the room lighting system 110 (step 522). The command, in this example, may indicate that “all lights” within the patient room 100 are to be activated at maximum intensity (e.g., 10 on a scale of 1 to 10.) In another embodiment, receipt of the command or value associated with the ALL LIGHTS button 402 could cause the control routine 302 to alert or otherwise communicate with the building automation workstation 162. In this embodiment, the building automation workstation 162 may direct, in response to the received command, the wireless field panel 108 or the field panel 150 to identify which of the lights 114 to 118 are to be activated. Similarly, the field panels 108 and 158 may be configured to control the position of the blinds in conjunction with the lights 114 to 118, the time of day and/or the temperature. Regardless of the specific device and/or mechanism for controlling each environmental component within the patient room 100, the control routine 302 and the unified patient room interface 200 provide a mechanism by which both the individual environmental element or a group of environmental elements are controlled and adjusted to satisfy a patient's individual comfort needs and healthcare requirements.

The command generated by the control routine 302 may be communicated to the SOAP interface 314. The SOAP interface 314, in turn, translates the commands and information utilized by the DALI protocol formatted command to generate a platform nonspecific data packet 318 (see FIG. 3B). The data packet or message 318 includes an XML envelope 320 that includes a header 322 and a body 324. The header 322 includes transaction and handshake information necessary to direct the information contained within the data packet 318 and the body 324 to the correct destination. In the present example, the header 322 may collectively or individually identify destination devices as the lights 114 to 118 deployed within the patient room 100. The body 324 contains the payload or commands and information necessary to command and/or control the destination devices. For example, the payload may include general and/or device specific environmental control information comprised of a number of individual environmental control parameters. The individual environmental control parameters, in turn, may be utilized by the system as a whole and/or a particular environmental control device in order to achieve or maintain a desired environmental condition within the patient room 100. In one exemplary embodiment, the environmental control parameters contained within the payload portion of the body 324 may include specific device identification information, e.g., the “AllLights” identifier, that corresponds to the initial user selection of the ALL LIGHTS button 402. Alternatively, the environmental control parameters contained within the payload portion of the body 324 may correspond to one or more preprogrammed configurations and scenes that may be implemented and customized by the user. In this way, the environmental control parameters, such as the specific device identification information, make up the environmental control information that may be communicated and exchanged to adjust a particular device or element within the patient room 100. In another embodiment, the environmental control parameters defined within the environmental control information may include settings, thresholds and values necessary to adjust a number of devices or elements within the patient room 100 according to a pre-defined program or environmental scheme. In this way, the body 324 may include a desired maximum output value or command, e.g., the value of 10, required to turn on all the lights within the patient room 100 when necessary for a patient examination.

Once the data packet 318 has been generated using the information needed to provide a DALI formatted communication to control and exchange information with the automation devices of the room lighting system 110. The data packet 318 may be communicated to the building automation workstation 162 (step 526) over the building automation network 160. The building automation workstation 162 may, in turn, convert the platform nonspecific data packet 318 (i.e., information contained within the XML envelope 320) back to the correct format for use by the lights 114 to 118. The restored or reformatted message and command contained within the data packet 318 is then communicated by the building automation workstation 162 to the field panel 158 or directly to the lights 114 to 118 via the building automation network 160. Upon receipt of the information within the data packet 318, the light levels of the overhead examination light 114, the patient reading light 116 and the bathroom light 118 are increased to maximum (e.g., a value of 10) to illuminate the patient room 100 at their highest intensity.

In operation, the data packet 318 may be delivered utilizing the building automation network 160 as a communication medium between, for example, the building automation workstation 162, the field panel 158 and the lights 114 to 118. Alternatively, the data packet 318 may be delivered via a wireless connection utilizing a wireless network established between, for example, the building automation workstation 162, the wireless field panel 108 and the lights 114 to 118. If the room lighting system 110 and/or the individual lights 114 to 118 are configured to provide feedback and/or confirmation that the command has been enacted (step 528), then the received confirmation may be stored in the memory 206 or storage module 210 and/or utilized to update the current state information associated with the lighting routine 302 (see 508). The control routine 300 may return to an idle state until another change of state or state event is detected (see 504).

In other embodiments, the user may interact with the user interface 400 to individually control the lights 114 to 118. For example, by selecting the READING LIGHT button 404 on the interface 400 and adjusting the lighting slider or control 412, the user can change or adjust the brightness of the patient reading light 116. Similarly, by selecting the NIGHT LIGHT button 406, which corresponds to the bathroom light 118, or the EXAMINATION LIGHT button 408, which corresponds to the overheard light 114, the intensity of each may be manually adjusted using the lighting slider 412. For example, by moving the slider 412a left or right, the intensity and brightness of a designated light may be decreased or increased. Alternatively, by selecting the UP lighting button 412b or the DOWN lighting button 412c, the intensity is incrementally adjusted by a fixed amount (e.g., each increment may correspond to a change of 1 on a 1 to 10 scale.)

In another embodiment, the control routine 302 may detect a change of state or state event that correspond to a detected connection of a media player (not shown) to the input 216 of the unified patient room interface 200 (step 504). Because this change of state impacts the operation of one or more automation devices operating within the patient room 100, the control routine 302 exits the idle state and continues to execute (step 505). The detected state event, in this example, corresponds to the entertainment routine 308 (step 510). Upon determination that the entertainment routine 308 is active, the control routine 302 may load volume and/or connection information associated with the television or monitor 132 (step 512). The control routine 302 may further determine the address and status of the television or monitor 132 associated with the detected change of state (step 520). In this embodiment, the state event corresponding to the connection of the media player to the input 216 may initiate the process of opening an audio channel between devices operable within the integrated entertainment system 130. For example, in response to the detected connection of the media player, the control routine 302 may detect and activate the audio module 218 and the attached speaker 220 of the unified patient room interface 200 as well as the speakers integral to the television or monitor 132.

The control routine 302 may generate or identify a specific command to establish an open communication channel according to any applicable protocol utilized by the integrated entertainment system 130 (step 522). This command or commands may provide for the digital music files or other digital media files stored on the media player to be streamed to the television 132 and the associated audio to be broadcast through the speaker 220 as well as the speakers integral to the television 132. As previously discussed, the command generated by the control routine 302 to open the channel may be communicated to the SOAP interface 314. The SOAP interface 314, in turn, converts (step 524) the original command into an XML data packet 318 (see FIG. 3B) for communication to the building automation workstation 162 (step 526). The building automation workstation 162, in turn, converts the XML data packet 318 and the command back to the correct format for use by the integrated entertainment system 130. The building automation workstation 162 may utilize the building automation network 160 to deliver the command the specified devices (i.e., the television 132 in this example) within the integrated entertainment system 130. Once the command generated by the control routine 302 has been communicated to the appropriate devices of the integrated entertainment system 130, the communication channel may be established and the media and/or audio files stored on the media player may be streamed throughout the patient room 100. If acknowledgement of the communication channel is provided (step 528), the current state information associated with the entertainment routine 308 (see 512) is updated. Upon completion of the update, or if is no update is performed, the control routine 302 may return to the idle state (see 504) in preparation for the next state event or user directed change in environmental conditions.

In yet another embodiment, the detected change of state (step 504) may be a temperature indication generated by the temperature sensor 152 (step 505). The temperature indication may be an analog or digital signal corresponding to the temperature within the patient room 100. For example, the temperature sensor 152 may detect that the temperature within the patient room 100 has increased or decreased and now equals 72° F. In this exemplary embodiment, the detected temperature indication reflects a change in the environmental conditions within the patient room 100 and as such corresponds to a state event. The state event including the detected temperature value (72° F.) may be communicated from the temperature sensor 152 to the HVAC unit 154 along the wired connection 157. The HVAC unit 154 may compare the detected temperature value to a stored threshold value (e.g., a threshold value of 70° F.) and increase the airflow and/or decrease the air temperature within the patient room 100 in an attempt to drive the ambient temperature to the threshold level.

The HVAC unit 154 may communicate the temperature indication, including the detected temperature value (72° F.), to the field panel 158 via the building automation network 160. In due course, the field panel 158 uploads or otherwise communicates the temperature indication to the building automation workstation 162 for further processing. The building automation workstation 162 may identify the temperature indication as a state event and flag it for transmission to the patient room interface 200. Alternatively, the building automation workstation 162 may simply retransmit the temperature indication, and the control routine 302 may identify the temperature indication as a state event (step 504). Because the temperature indication represents a sensor update, as opposed to a command that alters the operation of a device associated with the patient room 100, the control routine 302 updates the current state information (step 516) to reflect the detected temperature value (72° F.). The control and user interface 304 may, in turn, update the current temperature value 416 of user interface 400 to reflect the temperature value detected by the sensor 152. The control routine may subsequently return to the idle state to await another change of state (see 504). In operation, the user may manually adjust the temperature threshold, as discussed in connection with the lighting conditions and slider 412, by selecting temperature slider 414 and moving the slider 414a left or right to increase or decrease the temperature within the patient room 100. By selecting the UP temperature button 414b or the DOWN temperature button 414c, the temperature threshold is incrementally adjusted by degrees (e.g., each increment may correspond to a 1 degree change in the temperature threshold.)

In another embodiment, the control routine 302 may determine that a detected state event (step 504) isn't a sensor update (step 505) and doesn't correspond the lighting routine 306 (see 506), the integrated entertainment routine 308 (see 510), and the HVAC control routine 310 (see 514). In this embodiment, the state event could be an alarm activated on a predetermined date and/or at a predetermined time. In response to the detected state event, the control routine 302 may load or activate the program routine 312 (step 518). The program routine 312 may include predefined activities and commands to alter the patient room environment to a desired configuration. For example, the state event may be a timed alarm selected to prevent the afternoon sun from shining into, and increasing the heat of, the patient room 100. The program routine 312 may identify and utilize the positioning motor 122 and the plurality of shades 120 of the window shade control system 112, the light sensor 114b, and the lights 114 to 118 of the lighting system 110 and the temperature sensor 152 and HVAC unit 154 of the environmental control system 150 to adjust and/or maintain the conditions within the patient room 100 (step 520).

The control routine 302 may, in one embodiment, generate a data packet 318 for each device to be controlled or for each group of devices that communicate according to a common communication protocol (step 522). Alternatively, a single data packet 318 may be generated and utilize an XML envelope 320 that individually identifies the devices and commands to be implemented on those devices. For example, the control routine 302 may generate commands to control the lighting system 110 according to the DALI protocol. Similarly, the control routine 302 can generate commands to control the automation devices operating within the environment control system 150 according to the BACnet protocol.

The generated commands, in turn, may be converted by the SOAP interface 314 to a second protocol (i.e., the XML, platform independent protocol) utilized for the data packet 318 (step 524). The data packet 318, in turn, is communicated to the building automation workstation 162 for decoding via a second SOAP server/interface. Once the commands have been decoded, the building automation workstation 162 routes the commands to the specific automation devices identified in the headers 322 for execution of the commands contained in the body 324. In operation, commands and information contained in the data packet 318 may cause the positioning motor 122 to close the shades 120 until the ambient light within the patient room 100 reaches a predefined level as measured by the light sensor 114b. The commands and information contained in the data packet 318 may be further directed the HVAC unit 154 to increase airflow and/or decrease the temperature to maintain the temperature within the patient room 100. The operation of the HVAC unit 154 may be controlled in response to temperature indications provided by the temperature sensor 152 in order to minimize the overall energy usage. The operation of the HVAC unit 154 may be controlled in response to occupancy detection, wireless patient identification, and/or type of patient identification.

In another embodiment, the light sensor 114b may cooperate with both the lights 114 to 118 and the window shade control system 112 to maintain the ambient light within the patient room 100. The user may adjust the ambient light threshold via the user interface 400 and more particularly the AMBIENT LIGHT button 410. By adjusting the lighting and temperature thresholds, the control routine 302 can balance the energy usage of the HVAC unit 154 against the energy usage of the lighting system 110 to maintain the desired light and temperature environmental conditions.

In yet another embodiment, the user interface 400 may be replaced or augmented with one or more alternate user interfaces 600 and 700. These alternate user interfaces 600 and 700 may be accessible via the user interface 400 or may replace all or parts of the user interface 400. For example, when the user adjusts and moves the lighting slider or control 412, the control routine 302 and the control and user interface routine 304 may, based on the season, time of day, desired energy consumption or other criteria, generate and present the user interface 600 via the display 214. The exemplary user interface 600 allows user control and access to the window shade control system 112 to adjust the amount of natural light provided via the window 104.

Upon activation of the user interface 600, the lighting routine 306 portion of the control routine 302 may access and activate a shade control subroutine or other executable code necessary to interface with the window shade control system 112. As previously discussed, this process may begin with the retrieval and loading of the current state information (see step 508) from, for example, the memory 206, the workstation 162, and/or a direct communication request provided to the components of the shade control system 112 (see step 506). The lighting routine 306 may, in turn, provide the loaded information to the control and user interface routine 304 for presentation via the user interface 600.

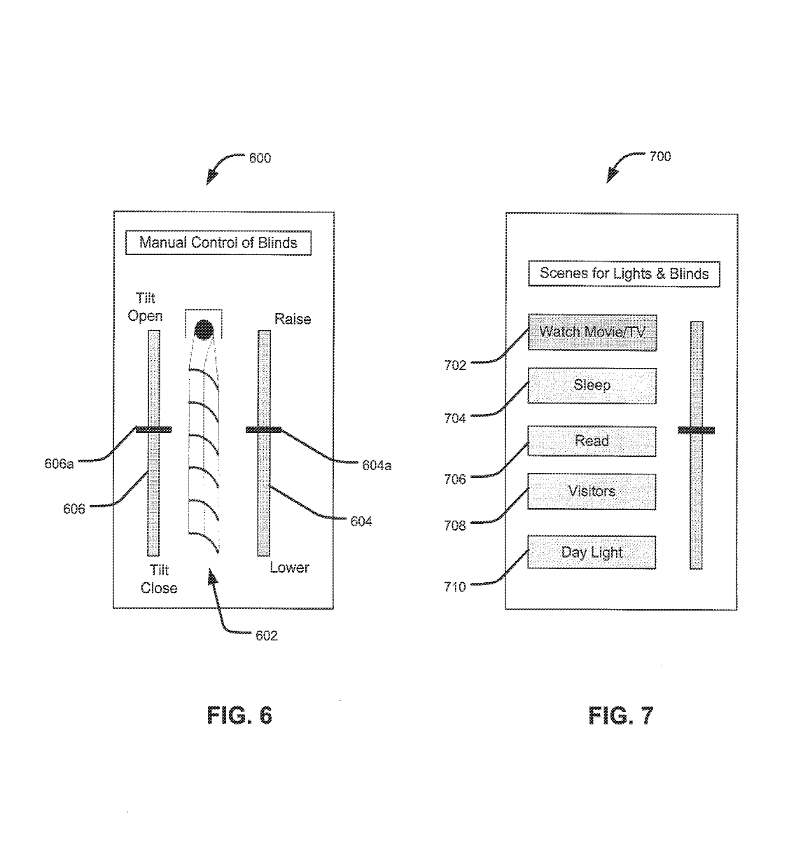

In one embodiment shown in FIG. 6, the user interface 600 may include a graphical representation 602 of the shades 120. Specifically, the position and angle of the individual shades 120 may be displayed. The user may access and customize these settings via interactive position and angle sliders 604 and 606. For example, by changing the position of the slider 606a, the user, via the control routine 302, directs the positioning motor 122 to alter the angle or tilt of the individual shades between an open position and a closed position. Altering and adjusting the tilt of each shade, allows the user to increase or decrease the amount of illumination and heat allowed through the window 104. Similarly, the user may raise or lower the entire bank of shades 120 by moving the slider 604a. Specifically, a change in the position of the slider 604a may be detected by the lighting routine 306 portion of the control and user interface routine 304 and quantified by the control routine 302. The quantified position information may, in turn, be transmitted as a data packet 318 to the building automation workstation 162. Depending upon the particular configuration of the system, the information contained within the data packet 318 may be utilized by the building automation workstation 162 to directly control the positioning motor 122 or may be provided to one or more of the field panels 108 and 158 which, in turn, communicate with and control the operation of the positioning motor 122.

The user interface 700 shown in FIG. 7 illustrates another embodiment and configuration that may be generated and displayed by the control and user interface routine 304 portion of the control routine 302. In this exemplary embodiment, the user interface 700 represents and includes multiple preprogrammed configurations and scenes that may be implemented and customized by the user. The individual scenes and configurations may, in one embodiment, be implemented in conjunction with a comprehensive environmental control system that maintains and optimizes the conditions and systems operable within the structure. By coordinating the operation of the individual scenes and configurations with the control scheme implemented throughout the structure, the conditions and environmental preferences of individual patients are addressed without sacrificing the efficiency and performance of the comprehensive environmental control system.

The scene 702, in this exemplary embodiment, may be selected when the user accesses information, movies and television programs using the integrated entertainment system 130. When the scene 702 is selected through the touchscreen display 214, the control routine 302 may load environmental control parameters such as conditions and thresholds which integrate and coordinate the operation of the room lighting system 110 including the window shade control system 112, the integrated entertainment system 130 and the environmental control system 150. For example, selection of the graphical icon corresponding to the scene 702 may cause an appropriate data packet 318 to be communicated to the building automation workstation 162 and subsequently to the field panels 108 and 158. The data packet 318 may initiate a stored macro or other sequence of environmental control parameters designed to adjust the systems 110, 112, 130 and 150. In one configuration, selection of the scene 702 results in the implementation of a first environmental control parameter that lowers the bank of shades 120 and alters the angle or tilt of the individual shades 120 to block the light from the window 194 from entering the patient room 100. Simultaneously, a second environmental control parameter associated with the scene 702 may cause the individual room lights 114, 116 and 118 to be dimmed to a preconfigured level to make movie or television watching easier for the patient.

In another embodiment, the user may select the scene 704 in order to configure the patient room 100 for sleeping. In this embodiment, selection of the sleep scene 704 causes the control routine 302 and the lighting routing 306 to implement one or more environmental control parameters designed to shut off or substantially reduce the intensity of the lights 114, 116 and 118. Simultaneously, the lighting routine 306, and more particularly the shade control subroutine, may direct the positioning motor 122 of the window shade control system 112 to close the shade bank and increase the shade angle or tilt in order to block ambient light from entering via the window 104.

The user may further associate a temperature setting or threshold with the sleep scene 704 in order to maintain the temperature of the patient room 100 at a desired level. For example, if the user prefers sleeping in a cool room, then selection of the sleep scene 704 may cause the control routine 302, the building automation workstation 162, and one or more of the field panels 108 and 158 to adjust the HVAC unit 154 until the sensor 152 registers the desired temperature. This temperature may further be governed as part of the overall environmental control scheme implemented for the structure. For example, range or degree of adjustment may be limited in order to reduce or control the energy consumption of the structure. In another embodiment, authorized medical personnel may override or further adjust these temperature settings based on the user's diagnosis and/or malady. Automated controls may override or further adjust temperature or other HVAC settings based on the type of patient.

Similarly selection of the reading scene 706 and the visitors scene 708 may cause the HVAC unit 154 as well as the systems 110, 112, 130 and 150 of the patient room 100 to reconfigure to the user's programmed specification. For example, when the user identifies the graphical icon corresponding to the reading scene 706 as displayed by the user interface 700, the control routine 302 may direct the lighting routine 306 to reduce the intensity of the overhead light 114 and increase or turn on the patient reading light 116. In other configurations, the control routine 302 may direct the entertainment routine 308 to turn-off or reduce the volume of the television 132. Selection of the graphical icon corresponding to the visitors scene 708, may cause the control routine 302 and the lighting routine 306 to increase the illumination level of the lights 114, 116 and 118.

Alternatively, the control routine 302 and the lighting routine 306 may implement a set of environmental control parameters configured to increase the light level within the patient room 100 by engaging the window shade control system 112 and opening the blinds to increase the natural light. If, in response to this change by the window shade control system 112, the light sensor 114b determines that the overall light level is below a preprogrammed threshold; then the control routine 302 and lighting routine 306 may increase the to increase the illumination level of the lights 114, 116 and 118 to compensate. In this way, the conditions requested by the user may be realized while the energy usage of the building may be minimized.

The daylight scene 710 may, in one embodiment, be configured to allow the control routine 302 and the environmental control system of the structure operate in conjunction to maintain and balance the temperature and lighting conditions within the patient room 100 with weather conditions outside the window 104. For example, the user may select the daylight scene 710 and specify a light level to maintain. The control routine 302 may communicate a data packet 318 containing the desired light level to the INSIGHT® application executing on the building automation workstation 162. The INSIGHT® application, in turn, may evaluate the user-defined illumination threshold against the ambient light readings detected via the light sensor 114b. The lighting system 110 and window shade control system 112 may be adjusted relative to each other in order to achieve the desired user-defined threshold. These systems may be further balanced with respect to a user-defined temperature threshold and the temperature detected by the sensor 150. For example, if the user-defined illumination threshold calls for a bright patient room 100, the amount of sunlight allowed through the window 104 by the window shade control system 112 may be balanced against the detected increase in ambient temperature. In this way, the environmental control system of the structure may balance the energy requirements of operating the HVAC unit 154 to maintain a temperature against the energy requirements of the lighting system 110 and the illumination allowed and controlled by the window shade control system 112.

The disclosed interface, systems and methods provide a holistic mechanism by which individual patient comfort is balanced against overall energy efficiency. In operation, the exemplary patient room interface 200, building automation workstation 162 and field panels 108 and 158 utilize seasonal and time of day information in conjunction with a customizable prioritization of resources to control and direct the systems 110, 112, 130 and 150 and/or the HVAC unit 154 within the patient room 100 and the overall structure. The customizable prioritization allows maintenance, controls and/or building operations personnel to define the order in which each system, element and device within the environmental control system are employed in order to maximize patient comfort and building efficiency. The control by the patient may be limited based on requirements for the type of patient, such as allowing the patient to adjust the number of air changes per hour within a given range greater than the number appropriate for the type of patient.

The use of occupancy detection may further simplify control and increase patient comfort. By detecting the patient in the room, customized settings appropriate for that specific patient and/or type of patient are implemented without the need for manual control. Manual control may be used to override, where allowed, settings. To save energy, the change in occupancy of a room is detected automatically, allowing automatic adjustment of the settings to a power savings mode, such as decreasing temperature, reducing or turning off lighting, changing pressure, and/or reducing the number of air changes per hour.

It should be understood that various changes and modifications to the presently preferred embodiments described herein will be apparent to those skilled in the art. Such changes and modifications can be made without departing from the spirit and scope of the present invention and without diminishing its intended advantages. It is therefore intended that such changes and modifications be covered by the appended claims.

What is claimed is:

1. A method for environmental control in a hospital, the method comprising:
operating a ventilation system for a room of the hospital at a first rate of air changes per hour;
detecting a presence of an occupant in the room of the hospital;
distinguishing the occupant as a patient from other types of occupants;
determining a type of patient for the patient;
controlling the operating of the ventilation system for the room such that the first rate is changed to a second rate in response to the detecting of the presence of the occupant and that the occupant is the patient, the second rate being based on the type of patient;
detecting that the patient is no longer in the room; and
controlling the operating of the ventilation system for the room such that the second rate is changed to the first rate in response to the detecting that the patient is no longer in the room.

2. The method of claim 1 wherein operating comprises circulating air while substantially maintaining a pressure.

3. The method of claim 1 wherein detecting the presence comprises detecting a tag worn by the patient as being located in the room.

4. The method of claim 1 wherein detecting the presence comprises detecting with a real time location system.

5. The method of claim 1 wherein distinguishing the occupant comprises looking up a detected identifier for the occupant in a database of identifiers referenced to individuals, the database including identifiers for staff of the hospital and for patients, including the patient.

6. The method of claim 1 wherein distinguishing comprises determining that the occupant is the patient and not a staff member.

7. The method of claim 1 wherein determining the type of patient comprises determining the patient as infectious.

8. The method of claim 1 wherein determining the type of patient comprises determining the patient as one of pediatric, burn, immune suppressed, infectious, or therapy.

9. The method of claim 8 wherein controlling from the first rate to the second rate comprises controlling with the first rate comprising an energy saving rate to the second rate comprising different rates for the different of the types of patients.

10. The method of claim 1 wherein determining the type comprises looking up the type in a database referencing patients with types.

11. The method of claim 1 wherein controlling from the first rate to the second rate comprises increasing the air changes per hour.

12. The method of claim 1 wherein detecting that the patient is not longer in the room comprises failing to detect the patient in the room.

13. The method of claim 1 wherein controlling from the second rate to the first rate comprises decreasing the air changes per hour.

14. The method of claim 1 further comprising:
detecting a patient individual identification of the patient; and
controlling temperature, lighting, blinds, or combinations thereof as a function of the patient individual identification.

15. In a non-transitory computer readable storage medium having stored therein data representing instructions executable by a programmed processor for environmental control in a medical facility, the storage medium comprising instructions for:
detecting a location of a patient in a medical facility;
identifying the patient or a patient category of the patient; and
controlling an environment local to the location of the patient as a function of the identified patient or the identified patient category of the patient.

16. The non-transitory computer readable storage medium of claim 15 wherein detecting the location comprises detecting, wirelessly, a tag worn by the patient in a room of the medical facility, wherein identifying comprises referencing a database of patients or patient categories with an identification of the tag received from the tag; and wherein controlling comprises controlling for the room.

17. The non-transitory computer readable storage medium of claim 15 wherein controlling comprises changing a number of air changes per hour setting of a ventilation system for a room of the medical facility based on the location being in the room and the patient category of the patient.

18. The non-transitory computer readable storage medium of claim 15 wherein controlling comprises changing a light setting, a blind setting, a temperature setting, or combinations thereof as a function of the identified patient, the settings having different values for different patients.

19. A system for environmental control in a medical facility, the system comprising:
a processor; and
a memory in communication with the processor and configured to store processor-executable instructions to:
wirelessly detect a mobile device in a room of the medical facility;
wirelessly receive an identifier of the mobile device;
determine a number of air changes per hour setting as a function of the identifier; and
control a ventilation system based on the number.

20. The system of claim 19 wherein the number is determined as a function of a type of patient assigned to the identifier.

21. The system of claim 19 wherein the identifier is assigned to a patient, and wherein the number is maintained at a first value for any identifier assigned to staff and is increased upon detection of the mobile device with the identifier assigned to the patient.
